(19) United States
(12) Patent Application Publication
(10) Pub. No.: US 2005/0240534 A1
(43) Pub. Date: Oct. 27, 2005

(54) Content price control system, method and recording medium

(76) Inventors: Junichi Yamamoto, Yokohama-shi (JP); Shinko Riku, Fuchu-shi (JP); Shinichi Matsukawa, Fuchu-shi (JP); Hidekazu Nishizawa, Machida-shi (JP); Masataka Yamada, Fuchu-shi (JP); Naota Akimoto, Tama-shi (JP); Taku Kato, Kamakura-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/107,753

(22) Filed: Apr. 18, 2005

Related U.S. Application Data
(63) Continuation of application No. PCT/JP03/11451, filed on Sep. 8, 2003.

(30) Foreign Application Priority Data
Oct. 18, 2002 (JP) 2002-305079

(51) Int. Cl. H04L 9/00; H04K 1/00; G06F 17/60; G10L 19/00

(52) U.S. Cl. 705/59; 705/52

(57) ABSTRACT

A content price control system according to an example of the invention comprises a unit which accepts identification data to identify a content, and route data showing a circulation route of the content, a unit which reads price control data in which the identification data and distribution data showing a price distributing rule of the content are corresponded to each other, from a recording unit and a unit which executes a process of distributing prices of the content to persons concerned with circulation engaged in circulation of the content, based on the distribution data corresponding to the identification data and the route data.

### CROSS REFERENCE TO RELATED APPLICATIONS

This is a Continuation Application of PCT Application No. PCT/JP03/11451, filed Sep. 8, 2003, which was published under PCT Article 21(2) in Japanese.

This application is based upon and claims the benefit of priority from prior Japanese Patent Application No. 2002-305079, filed Oct. 18, 2002, the entire contents of which are incorporated herein by reference.

### BACKGROUND OF THE INVENTION

1. Field of the Invention

The present invention relates to a content control system, method and recording medium for distributing prices of a digital content.

2. Description of the Related Art

Along with the development of the information-oriented society, a content circulation system for distributing digital contents, for example, electronic books, electronic newspapers, music data, still image data, moving image data and so forth, to user terminals are in use.

In circulation of a digital content, there is case where an encrypted digital content (hereinafter, encrypted content) and a decoding key is separately provided to a user terminal.

In circulation of a digital content, there are many companies or individuals.

Hereinafter, those who is engaged in the circulation of the digital content is defined as person concerned with circulation. For example, persons concerned with circulation include a content provider who creates and provides the digital content, content distributor (content vendor) who distributes the encrypted content, key controller who controls and distributes an encryption key, accounter who collects and distributes proceeds, a user who uses the digital content and so forth.

Functions of persons concerned with circulation such as creation and provision of the digital content, distribution of encrypted the content, control and distribution of the encryption key, collection and distribution of the proceeds and so forth, are conducted by different companies in some cases, and are made by a same company in other cases.

In some cases, not a company but an individual is engaged in the circulation of the digital content. In order to facilitate the digital content circulation, it is important for appropriate prices to be paid to persons concerned with circulation.

With regard to the content circulation system that distributes the digital content, encrypted content or decoding key, some accounting method and proceeds distribution methods have already been proposed.

For example, in Patent Document 1 (Jpn. Pat. Appln. KOKAI Publication No. 9-73487) and Patent Document 2 (Jpn. Pat. Appln. KOKAI Publication No. 2002-133147), mechanisms for distributing proceeds between content distributors and other companies are described.

In Patent Document 3 (Jpn. Pat. Appln. KOKAI Publication No. 2001-5877), amounts that the content provider and content distributor ask for are registered in a system of the accounter, and according to the registered amounts, sale charges are determined by the accounter, and the sale charges are distributed to the content provider and content distributor by the accounter.

In Patent Document 4 (Jpn. Pat. Appln. KOKAI Publication No. 2002-41993), an art is described, where at request for the decoding key from the user (content user) to the key controller, a charge and shop information and so forth are recorded in an accounting settlement server.

In Patent Document 5 (Jpn. Pat. Appln. KOKAI Publication No. 2002-229960), an art is described, where in copying the encrypted content between user terminals, content circulation route information is recorded, and the key is issued or accounting is carried out according to the distribution route information.

In Patent Document 6 (Jpn. Pat. Appln. KOKAI Publication No. 9-73480), an art is described, where content sale prices are changed according to content sale periods.

As mentioned above, in the circulation of the digital content for separately distributing the encrypted content and the decoding key, there already exists system that determines a sale amount to be collected from the user, and distributes it among plural persons concerned with circulation.

However, the existing system lacks flexibility in distribution of prices. For example, in the existing system, it is difficult for the content distributor to conduct their original sale promotion campaign such as “a free digital content is provided to a user who purchases 10 digital contents” and the like, which has been a problem with the prior art.

Further, for example, in the existing system, it is difficult to pay prices for a personal circulation of the digital content among users such as “when user A introduces the digital content to user B, part of money that the user B pays is transferred to the user A” and so forth, which has been another problem with the prior art.

The present invention has been made in consideration of the above problems in the prior art, accordingly, the object of the invention is to provide a content price control system, a method and a program for flexibly accounting digital contents.

### BRIEF SUMMARY OF THE INVENTION

A content price control system according to the first example of the invention comprises:
a unit which accepts content identification data to identify a digital content, and route data showing a circulation route of the digital content;
a unit which reads price control data in which the content identification data and distribution data showing a price distributing rule of the digital content are corresponded to each other, from a recording unit; and
an execution unit which executes a process of distributing prices of the digital content to persons concerned with circulation engaged in circulation of the digital content, based on the distribution data corresponding to the content identification data and the route data.

A content price control system according to the second example of the invention comprises:
a unit which accepts content identification data to identify an encrypted digital content, and route data showing a circulation route of the digital content;
a unit which reads price control data in which the content identification data and distribution data showing a price distributing rule of the digital content are corresponded to each other, from a recording unit; and
a unit which executes a process of distributing prices of the digital content to persons concerned with circulation engaged in circulation of the digital content, according to distribution of a decoding key for use in decoding the digital content, based on the distribution data corresponding to the content identification data and the route data.

A content price control system according to the third example of the invention comprises:
a unit which accepts content identification data to identify a digital content, and route data showing a circulation route of the digital content;
a unit which reads price control data in which the content identification data, and distribution data showing a price setting rule set according to a accounting form of the digital content, and a price distributing rule of the digital content are corresponded to each other, from a recording unit;
a selecting unit which selects a program for executing a distribution process according to the accounting form by use of the distribution data and the route data as parameters, based on the price setting rule corresponding to the content identification data; and
a unit which executes a process of distributing prices of the digital content to persons concerned with circulation engaged in circulation of the digital content, based on the distribution data corresponding to the content identification data and the route data and the program selected by the selecting unit.

A local content price control system according to the fourth example of the invention comprises:
a unit which accepts a dividend calculation command, from a content price control system which distributes prices of a digital content to persons concerned with circulation engaged in circulation of the digital content;
a unit which executes a dividend calculation, according to the calculation command, based on distribution data showing a price distributing rule of the digital content of local; and
a unit which provides a dividend calculation result to the content price control system.

A key control system according to the fifth example of the invention comprises:
a key distributing unit which accepts content identification data to identify an encrypted digital content, and route data showing a circulation route of the digital content from a distribution destination of the digital content, and provides a decoding key corresponding to the content identification data to the distribution destination;
a unit which reads price control data in which the content identification data and distribution data showing a price distributing rule of the digital content are corresponded to each other, from a recording unit;
an execution unit which executes a process of distributing prices of the digital content to persons concerned with circulation engaged in circulation of the digital content, based on the distribution data corresponding to the content identification data and the route data; and
an accounting unit which records price data obtained by the process by the execution unit.

In the sixth example of the invention, a content circulation system for distributing an encrypted digital content recorded in a content provision system to a distribution destination by a content distribution system, and distributing a decoding key for use in decoding the digital content to the distribution destination by a key control system,
the key control system comprising:
a unit which accepts content identification data to identify the digital content, and route data showing a circulation route of the digital content from the distribution destination, and provides the decoding key corresponding to the content identification data to the distribution destination;
a unit which reads price control data in which the content identification data and distribution data showing price distributing rule of the digital content are corresponded to each other, from a recording unit;
an execution unit which executes a process of distributing prices of the digital content to persons concerned with circulation engaged in circulation of the digital content, based on the distribution data corresponding to the content identification data and the route data; and
an accounting unit which records price data obtained by the process by the execution unit, the content provision system executes a setting of the portion whose setting authority operator of the content provision system has of the distribution data, and
the content distribution system executes a setting of the portion whose setting authority operator of the content distribution system has of the distribution data.

In the seventh example of the invention, a method of distributing prices of a digital content by a computer, comprises:
accepting content identification data to identify the digital content, and route data showing a circulation route of the digital content, and reading price control data in which the content identification data and distribution data showing a price distributing rule of the digital content are corresponded to each other, from a recording unit; and
executing a process of distributing prices of the digital content to persons concerned with circulation engaged in circulation of the digital content, based on the distribution data corresponding to the content identification data and the route data.

In the eighth example of the invention, a recording medium for recording a program which causes a computer to function as:
a unit which accepts content identification data to identify a digital content, and route data showing a circulation route of the digital content;
a unit which reads price control data in which the content identification data and distribution data showing a price distributing rule of the digital content are corresponded to each other; and
an execution unit which executes a process of distributing prices of the digital content to persons concerned with circulation engaged in circulation of the digital content, based on the distribution data corresponding to the content identification data and the route data.

In the ninth example of the invention, a recording medium for recording a program which causes a computer to function as:
a unit which accepts a dividend calculation command, from a content price control system which distributes prices of a digital content to persons concerned with circulation engaged in circulation of the digital content;
a unit which executes a dividend calculation, according to the calculation command, based on distribution data showing a price distributing rule of the digital content of local; and
a unit which provides a dividend calculation result, to the content price control system.

### BRIEF DESCRIPTION OF THE SEVERAL VIEWS OF THE DRAWING

FIG. 1 is block diagram showing an example of the structure of a content circulation system according to the embodiment of the invention.

FIG. 2 is a block diagram showing an example of a content price control unit arranged in a key control system.

FIG. 3 is a block diagram showing an example of a local content price control unit.

FIG. 4 is a figure showing an example of a content package.

FIG. 5 is a flow chart showing an example of a process of a content circulation system.

FIG. 6 is a block diagram showing an example of data flow between a content provision system and a key control system.

FIG. 7 is a block diagram showing an example of data flow between a content provision system and a content distribution system and a user terminal.

FIG. 8 is a block diagram showing an example of data flow between a user terminal and a key control system and a content distribution system.

FIG. 9 is a figure showing an example of price control data.

FIG. 10 is a flow chart showing an example of a sale price calculation process executed by a content price control unit of a key control system.

FIG. 11 is a block diagram showing an example of data sent and received between a content price control unit of a key control system and a key distributing unit 22.

FIG. 12 is a figure showing an example of local price control data recorded out of a key control system.

FIG. 13 is a flow chart showing an example of a process of a content circulation system in the case where local price control data is recorded out of a key control system.

FIG. 14 is a block diagram showing data flow in the case where local price control data is recorded out of a key control system.

### DETAILED DESCRIPTION OF THE INVENTION

An embodiment according to the present invention will be illustrated in more details by reference to the attached drawings hereinafter. In all the drawings for explaining the embodiment, a like reference symbol is allotted to a like component, and repeated explanations thereof are omitted.

In the embodiment, a content circulation system that enables to carry out flexible accounting to circulation of a digital content.

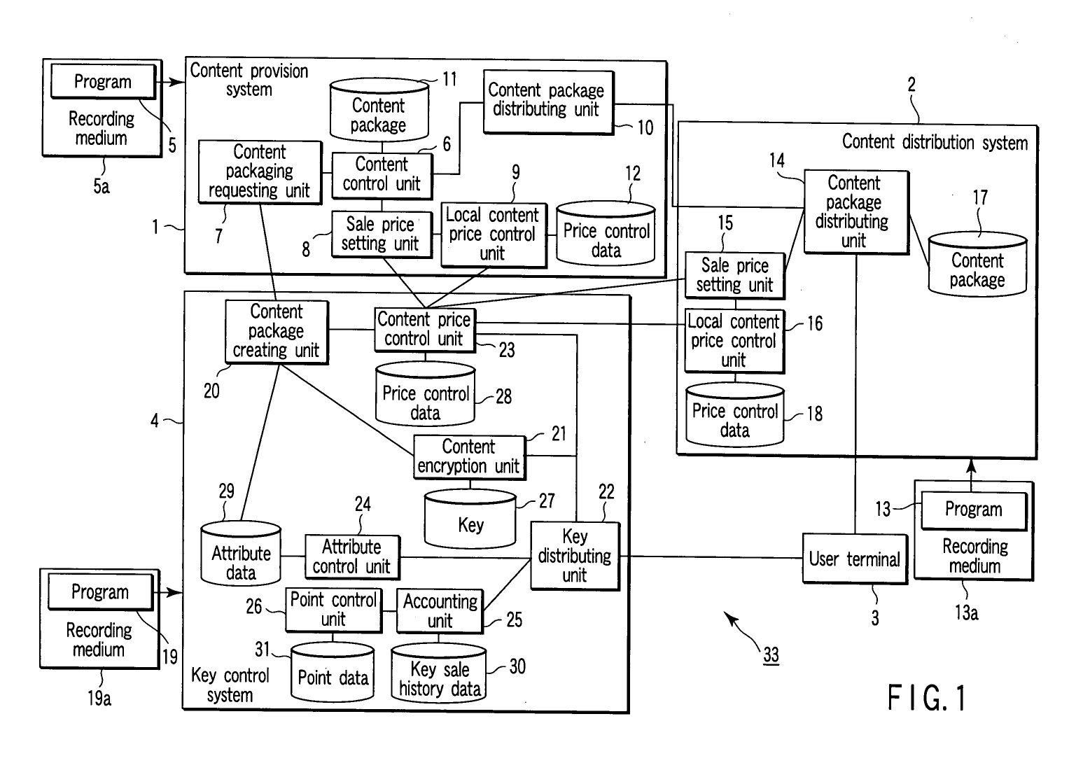

FIG. 1 is block diagram showing an example of the structure of a content circulation system according to the embodiment.

A content distribution system 33 according to the embodiment has a content provision system 1, a content distribution system 2, a user terminal 3, and a key control system 4.

The content provision system 1 is operated by a provider of a digital content. The content provision system 1 reads a program 5 recorded in a recording medium 5a, and executes it, thereby realizes functions of a content control unit 6, a content packaging requesting unit 7, a sale price setting unit 8, a local content price control unit 9, and a content package distributing unit 10.

The content control unit 6 records a content package into a recording device 11, and reads the content package recorded in the recording device 11. The content package has an encrypted content.

The content packaging requesting unit 7 provides a packaging command of an original digital content to the key control system 4, and accepts the content package from the key control system 4, and provides it to the content control unit 6.

The sale price setting unit 8 provides the key control system 4 with a setting command for the content provider to set a distributing rule of the digital content price at its own authority.

Further, the sale price setting unit 8 provides a setting command of price control data peculiar to the content provider to the local content price control unit 9.

The local content price control unit 9, according to the setting command of price control data peculiar to the content provider, records the peculiar price control data into a recording device 12.

Further, the local content price control unit 9 refers to the price control data recorded in the recording device 12, and executes a calculation of dividends peculiar to the content provider according to a dividend calculation command accepted from the key control system 4, and provides a calculation result to the key control system 4.

The content package distributing unit 10, according to a digital content distribution request accepted from the content distribution system 2 or the user terminal 3, adds content provider identification data to route data included in the content package corresponding to the distribution request, and sends this content package to a distribution request destination.

The content distribution system 2 is operated by a content distributor. The content distribution system 2 reads a program 13 recorded in a recording medium 13a, and executes it, thereby realizes functions of a content package distributing unit 14, a sale price setting unit 15, a local content price control unit 16.

Among content distributors, a content distributor who accepts distribution of the content first from the content provider is defined as a first content distributor. Thereafter, at every time when a content distributor accepts the content from other content distributor, the order of the content distributor is incremented.

The content package distributing unit 14 records the content package accepted from the content provision system 1 into a recording device 17.

Further, the content package distributing unit 14, according to the digital content distribution request accepted from other content distribution system or the user terminal 3, reads the content package corresponding to the distribution request from the recording device 17, and adds content distributor identification data to the route data included in the content package corresponding to the distribution request, and sends this content package to the distribution request destination.

The sale price setting unit 15 provides the key control system 4 with a setting command for the content distributor to set the distributing rule of the digital content price at its own authority.

Further, the sale price setting unit 15 provides a setting command of price control data peculiar to the content distributor to the local content price control unit 16.

The local content price control unit 16, according to a setting command of price control data peculiar to the content distributor, records the peculiar price control data into the recording device 18.

Further, the local content price control unit 16 refers to the price control data recorded in the recording device 18, and executes a calculation of a dividend peculiar to the content distributor according to the dividend calculation command accepted from the key control system 4, and provides a calculation result to the key control system 4.

The user terminal 3 accepts the content package, and provides the key control system 4 with a decoding key distribution command, and on receiving a decoding key from the key control system 4, decodes the encrypted content included in the content package.

The key control system 4 is operated by a key control center as a company that distributes the decoding key. The key control system 4 reads a program 19 recorded in a recording medium 19a, and executes it, thereby realizes functions of a content package creating unit 20, a content encryption unit 21, a key distributing unit 22, a content price control unit 23, an attribute control unit 24, an accounting unit 25, and a point control unit 26.

The content package creating unit 20 encodes a digital content by use of the content encryption unit 21 based on the packaging command accepted from the content provision system 1, and creates the content package including the encrypted content, and provides the content package to the content provision system 1.

The content encryption unit 21 encodes the digital content, and records the decoding key into a recording device 27.

Further, the content encryption unit 21, in response to a request from the key distributing unit 22, reads the decoding key corresponding to the encrypted content from the recording device 27, and provides the decoding key to the key distributing unit 22.

The key distributing unit 22, on receiving a decoding key distribution command of the encrypted content from the user terminal 3, requests for the decoding key corresponding to the encrypted content to the content encryption unit 21, and provides the decoding key accepted from the content encryption unit 21 to the user terminal 3.

Further, the key distributing unit 22 provides a price data calculation command to the content price control unit 23, and provides price data accepted from the content price control unit 23 to the attribute control unit 24, and provides the price data changed by the attribute control unit 24 to the accounting unit 25.

The content price control unit 23, based on a price control data recorded in a recording device 28, calculates the price data where digital content prices are distributed to persons concerned with circulation, and provides the price data to the key distributing unit 22.

The attribute control unit 24 judges a group to which the person concerned with circulation belong based on attribute data recorded in a recording device. 29, and changes the price data according to a specified rule corresponding to the group, and provides the changed price data to the key distributing unit 22.

The accounting unit 25 updates key sale history data recorded in a recording device 30 based on the changed price data.

The point control unit 26 updates point data recorded in a recording device 31 according to the price data or the key sale history data.

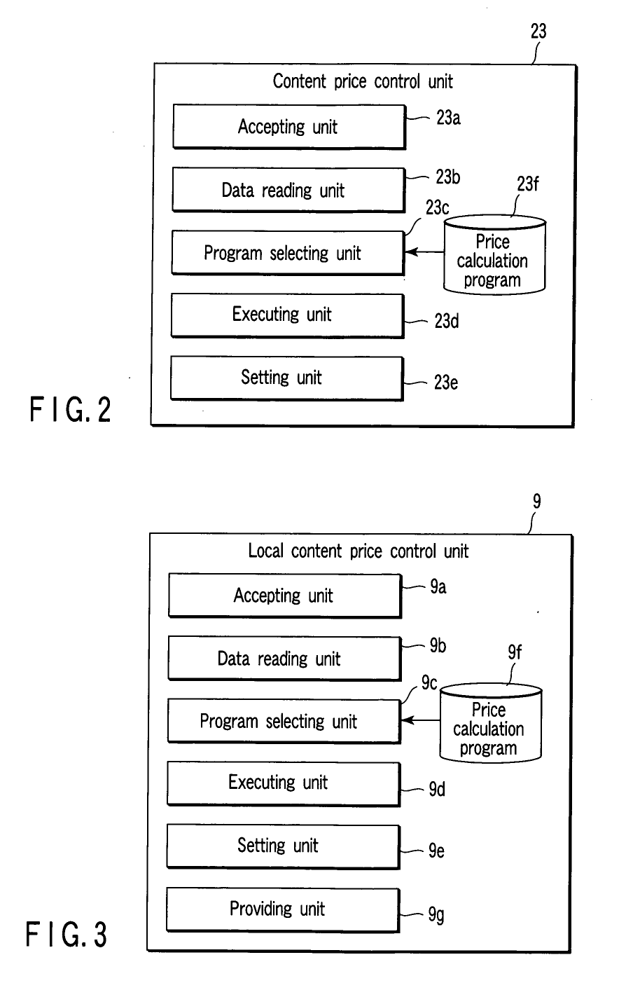

FIG. 2 is a block diagram showing an example of the content price control unit 23 arranged in the key control system 4.

The content price control unit 23 has an accepting unit 23a, a data reading unit 23b, a program selecting unit 23c, an executing unit 23d, a setting unit 23e, and a recording device 23f.

The accepting unit 23a accepts content identification data for identifying the encrypted content (hereinafter, referred to as “content ID”), and an encrypted content route data from the key distributing unit 22.

The data reading unit 23b reads the price control data recorded in the recording device 28. In the price control data, the content ID, a price-setting rule set according to an accounting form of the encrypted content, and a distribution table showing price distributing rule of the encrypted content are coordinated. The distribution table may include reference data showing a request destination that requests the content provision system 1 or the content distribution system 2 to calculate dividends.

The program selecting unit 23c selects a price calculation program for executing a distribution processing according to the accounting form by use of the distribution table and the route data as parameters, based on the price setting rule corresponding to the content ID. The price calculation program is recorded in the recording device 23f.

The executing unit 23d executes a process to distribute the digital content prices to persons concerned with circulation engaged in the circulation of the encrypted content that the content ID indicates, based on the distribution table corresponding to the content ID, route data, and selected price calculation program, and creates price data.

Further, when the reference data to the local content price control unit 9 or the local content price control unit 16 is included in the distribution table, the executing unit 23d provides a dividend calculation command to a calculation request destination that this reference data indicates, and accepts a dividend calculation result from the calculation request destination. Then, the executing unit 23d changes the price data using the dividend calculation result.

The setting unit 23e, according to the setting command accepted from the content provision system 1 or the content distribution system 2, sets the portion on which person concerned with circulation who handed over the setting command has setting authority among the distribution table recorded in the recording device 28.

FIG. 3 is a block diagram showing an example of the local content price control unit 9. Note that the local content price control unit 16 may have the same structure.

In FIG. 3, the local content price control unit 9 has the same structure as that of the content price control unit 23, however, it may be of a different structure.

An accepting unit 9a of the local content price control unit 9 accepts a calculation command from the content price control unit 23.

A data reading unit 9b reads local price control data recorded in the recording device 12. In the local price control data, content ID, price-setting rule set according to an accounting form of an encrypted content, and a local distribution table showing a price distributing rule of the encrypted content are coordinated.

A program selecting unit 9c selects a local price calculation program for executing a distribution processing according to the accounting form by use of the local distribution table and route data as parameters, based on a local price setting rule corresponding to the content ID. The local price calculation program is recorded in a recording device 9f.

An executing unit 9d executes a process to distribute digital content prices to persons concerned with circulation engaged in the circulation of the encrypted content that the content ID indicates, based on the local distribution table corresponding to the content ID, the route data, and the selected local price calculation program, and obtains a dividend calculation result.

A setting unit 9e, according to the setting command accepted from the content provider, sets the local distribution table recorded in the recording device 12.

A providing unit 9g provides the dividend calculation result to the content price control unit 23.

In the embodiment, the distribution route of the encrypted content is recorded as route data. The key control center distributes content sale money to persons concerned with circulation that the route data indicates.

The route data of the encrypted content includes identification data of persons concerned with circulation engaged in the circulation of the encrypted content (hereinafter referred to as “persons concerned with circulation ID”).

The persons concerned with circulation ID is controlled by the attribute control unit 24 of the key control system 4.

The key control system 4 controls the decoding key and the price control data. Further, other persons concerned with circulation than the key control center, at necessity, independently control local price control data.

The user terminal 3 provides user ID, the content ID, the route data to the key control system 4 at request of the decoding key.

The content price control unit 23 calculates sale price based on the price control data and the route data, and carries out an accounting processing to a user.

The key distributing unit 22 provides the decoding key to the user terminal 3.

To persons concerned with circulation engaged in the circulation of the encrypted content, sale money is distributed according to the price setting rule set in the price control data.

In this distribution, normally, the price control data of the key control system 4 is referred to. However, when local price control data is set independently by a person concerned with circulation according to desire of the person concerned with circulation, the local price control data is also referred to.

Persons concerned with circulation include the content provider, the content distributor, the key control center, the user and so forth. The content provider, content distributor, key control center, and user play respectively different roles.

The content provider creates a digital content, and supplies a content package including an encrypted content to a distribution request side. For example, a publishing company, TV production office and the like become the content providers.

The Content distributor distributes the content package created by the content provider to the user and another content distributor. For example, a book store, rental shop and the like become the content distributors.

The key control center encodes the digital content according to a request from the content provider, controls a decoding key, and distributes the decoding key to the user in response to a request from the user, and carries out accounting to the user.

The user uses the digital content. For example, a reader of electronic book, and video viewer become the users.

In some cases, others than the above 4 kinds of persons concerned with circulation are included in persons concerned with circulation. For example, The key control center may be engaged solely in key control, and another company may carry out accounting.

Further, among the roles of the above 4 kinds of persons concerned with circulation, plural roles may be played by a single company or individual.

In the embodiment, A kind and format of the digital content are arbitrary. As examples of the digital content, there is image data, an electronic book, music data, moving image data and so forth.

In the embodiment, the digital content is processed and the content package is created, and content package is sent and received among persons concerned with circulation.

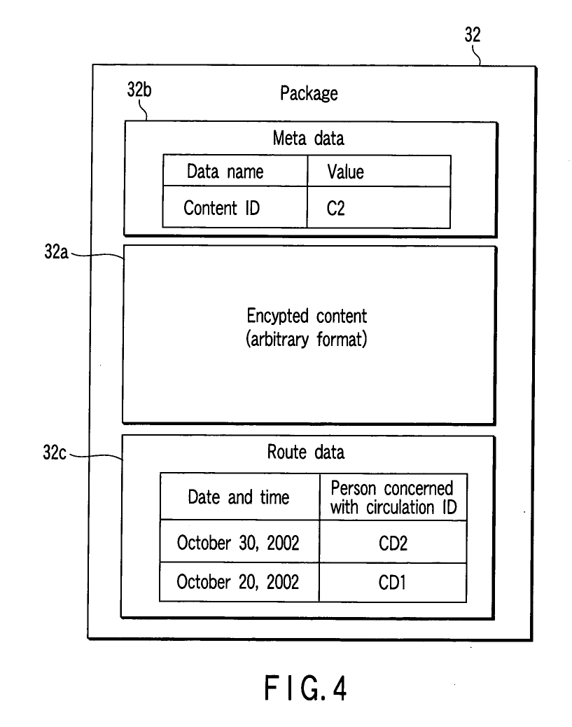

FIG. 4 is a figure showing an example of a content package.

A content package 32 has an encrypted content 32a as an encrypted digital content, meta data 32b, and route data 32c.

The meta data 32b includes a content ID. In the example in FIG. 4, the content ID “C2” is included therein.

The route data 32c includes, for example, person concerned with circulation ID showing person concerned with circulation engaged in the circulation of the digital content such as the content distributor, the user and so forth.

In the route data 32c in FIG. 4, the persons concerned with circulation ID and the date and time of content acquisition are recorded. However, as data to be registered in the route data, the date and time is not necessarily required. Further, the route data 32c may include other data than date and time.

The route data in FIG. 4 shows that a person concerned with circulation “CD1” acquired this content package on Oct. 20, 2002, and on Oct. 30, 2002, the person concerned with circulation “CD1” copied this encrypted content and supplied it to a person concerned with circulation “CD2”. At the moment when the encrypted content is copied, the date and time “Oct. 30, 2002” and the person concerned with circulation ID “CD2” showing a copy provision destination are added to the route data 32c.

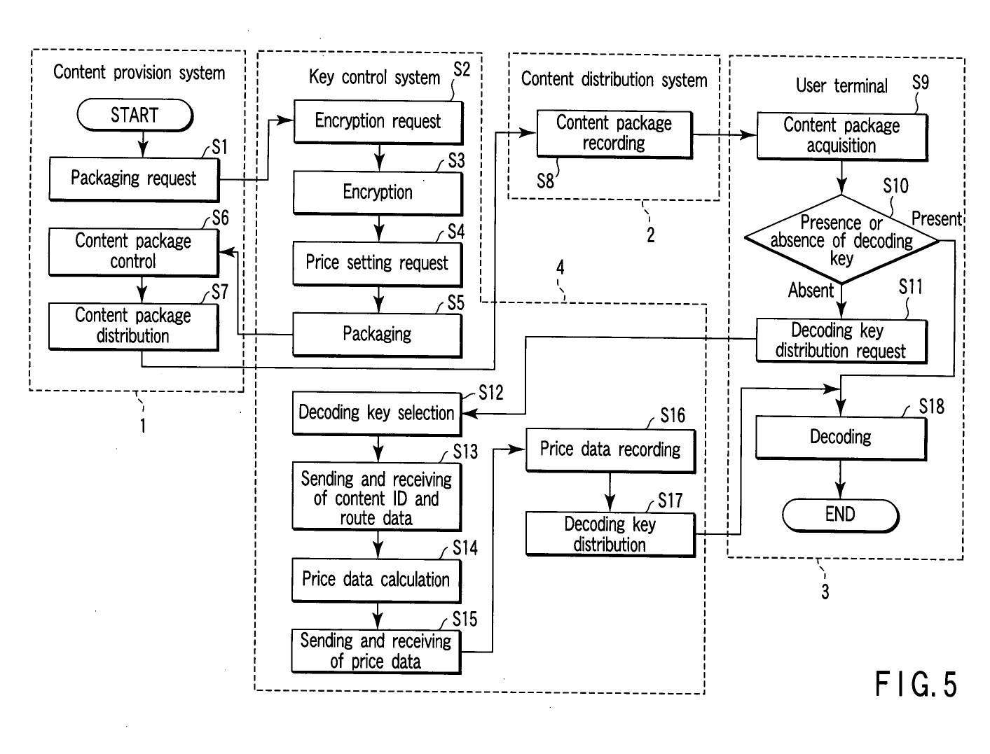

FIG. 5 is a flow chart showing an example of the process of a content circulation system 33 according to the embodiment.

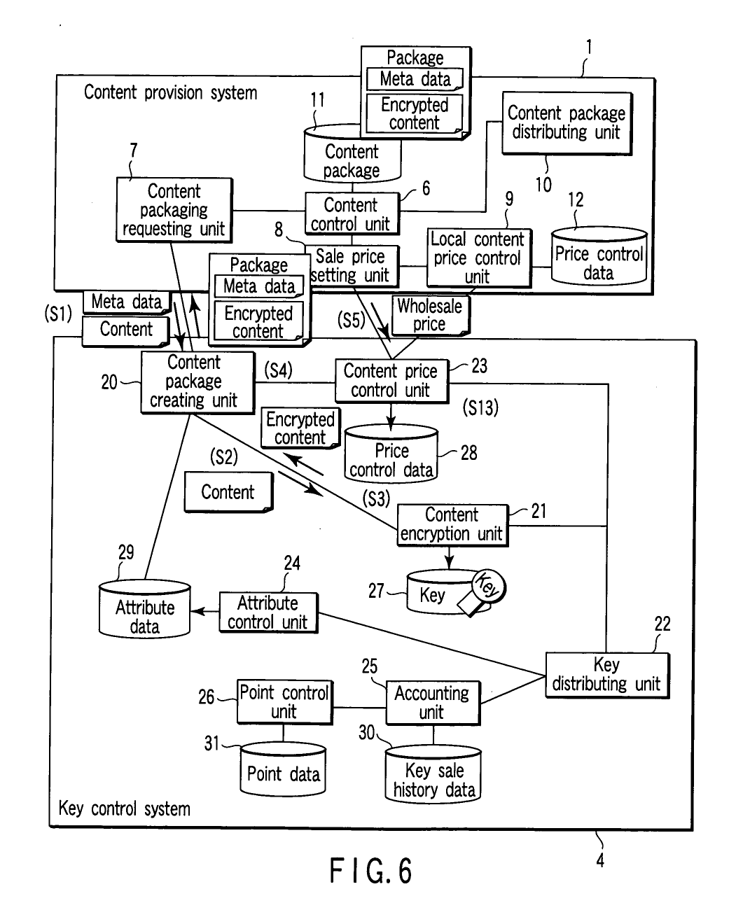

FIGS. 6 to 8 are block diagrams showing circulation of the encrypted content and decoding key in the content circulation system 33 according to the embodiment.

FIG. 6 shows an example of data flow between the content provision system 1 and the key control system 4.

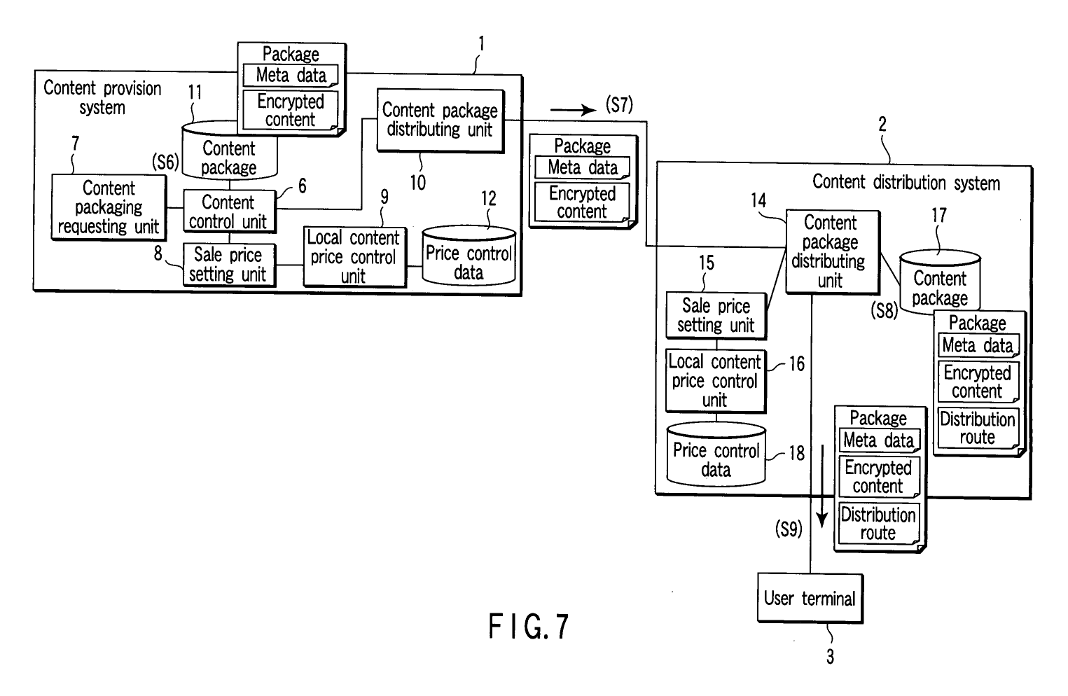

FIG. 7 shows an example of data flow between the content provision system 1 and the content distribution system 2 and the user terminal 3.

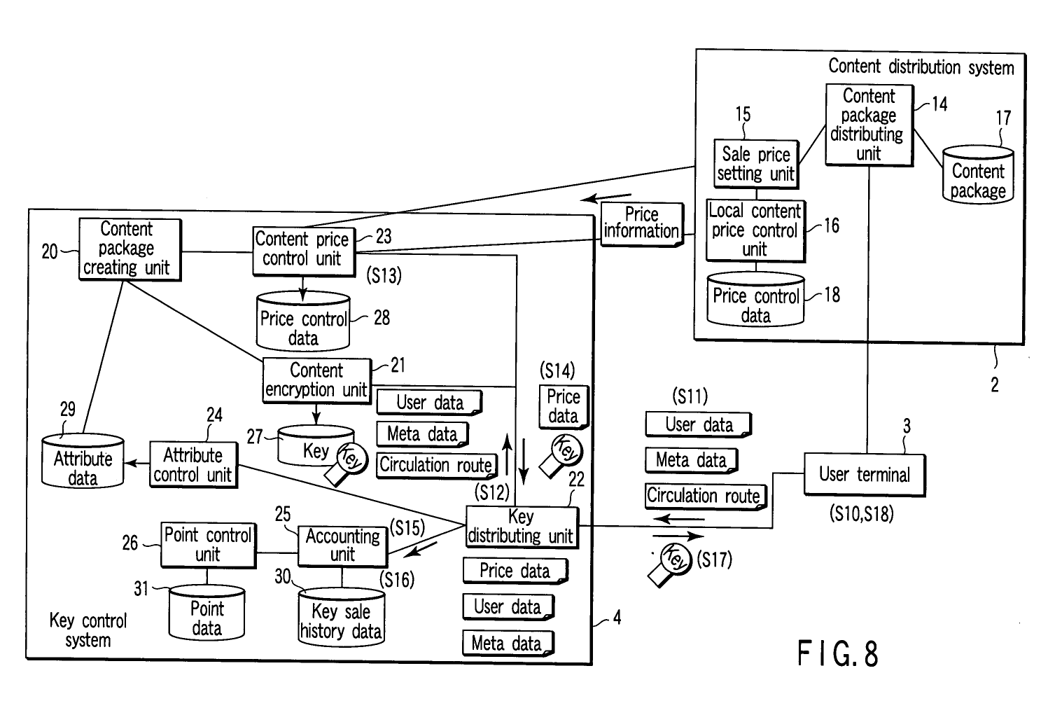

FIG. 8 shows an example of data flow between the user terminal 3 and the key control system 4 and the content distribution system 2.

In step S1, the content packaging requesting unit 7 accepts a content packaging request from the content provider, and requests the content package creating unit 20 to package the digital content.

The content packaging requesting unit 7, in requesting the content package creating unit 20 to package the digital content, provides the digital content and packaging meta data to the content package creating unit 20, the packaging meta data include person concerned with circulation ID showing the content provider, data for use in price setting and so forth.

In step S2, the content package creating unit 20 requests the content encryption unit 21 to encode the digital content.

In step S3, the content encryption unit 21 encodes the digital content, and records a decoding key for use in decoding an encrypted content into the recording device 27, and sends the encrypted content back to the content package creating unit 20.

In step S4, the content package creating unit 20 selects the data for use in price setting from packaging meta data, and requests the content price control unit 23 to set a price.

In step S5, the content package creating unit 20 creates a content package, and sends the content package back to the content packaging requesting unit 7.

In step S6, the content packaging requesting unit 7 transfers the content package to the content control unit 6, and requests it to control the content package.

In step S7, the content package distributing unit 10 distributes the content package to the content package distributing unit 14 of the content distribution system 2.

In step S8, the content package distributing unit 14 adds its ID to the route data of the content package, and records the content package into the recording device 17.

When the content package is distributed among content distributors, the same procedures as the step S7 and the step S8 are repeated.

When the content package is distributed among plural content distributors, plural content distributor ID's are recorded into the route data. When the content package is copied and sent and received among plural users too, at the moment of copying, user ID's are added to the route data. In this manner, plural ID's may be recorded into the route data.

In step S9, the user terminal 3 accepts the content package from the content package distributing unit 14 of the content distribution system 2.

In step S10, the user terminal 3, on accepting a use request of the encrypted content in the content package from a user, checks whether there is a decoding key or not. When the decoding key has already been acquired, step S18 is executed.

When the decoding key has not been acquired yet, in step S1, the user terminal 3 requests the key distributing unit 22 of the key control system 4 to distribute the decoding key. When the distribution of the decoding key is requested, the user data, meta data, and route data are supplied from the user terminal 3 to the key distributing unit 22. The user data includes at least user ID. The meta data includes at least the content ID.

In step S12, the key distributing unit 22 provides the content ID in meta data to the content encryption unit 21, and acquires the decoding key.

In step S13, the key distributing unit 22 provides the content ID and the route data to the content price control unit 23.

In step S14, the content price control unit 23 refers to the price control data recorded in the recording device 28, and based on the content ID and the person concerned with circulation ID included in the route data, calculates sale money dividend amounts and sale prices (total amount of the dividend) among persons concerned with circulation, and sends price data showing the sale money dividend amounts and sale prices back to key distributing unit 22.

In step S15, the key distributing unit 22 provides the user ID in the user data, the content ID in the meta data, and the price data to the accounting unit 25.

In step S16, the accounting unit 25 updates the key sale history data recording in a recording device 30, based on the user ID, the content ID, and the price data.

In step S17, the key distributing unit 22 of the key control system 4 provides the decoding key to the user terminal 3.

In step S18, the user terminal 3 decodes the encrypted content by use of the decoding key, and makes the digital content available on the user terminal 3.

Hereinafter, the content price control unit 23 is explained in details.

Persons concerned with circulation may set the price control data to be recorded into the recording device 28 from the outside of the key control system 4. Prices are set by various methods. In the embodiment, a case where price setting rules are set per content ID is explained.

Price setting rules include, for example, a wholesale/sale price setting rule, a distribution rate setting rule and so forth.

In the wholesale/sale price setting rule, the content provider, the first content distributor and the key control center set the amounts to become their own shares, and the total sum thereof becomes a sale price to a user. The first content distributor may distribute part of its share to the n-th content distributors.

In the distribution rate setting rule, content sale prices, and distribution rates thereof to persons concerned with circulation are set.

The price setting rule is corresponded mainly with the price calculation program (price calculation function) and the distribution table.

The price calculation program is a program for determining a sale price of right to use of the content, and amounts that persons concerned with circulation acquire. To the distribution table, various kinds of data to be referred to by the price calculation program are set.

In system implementation, the price calculation program and the distribution table may be implemented separately, or may be implemented without clear distinction. In the embodiment, the distribution table is recorded into the recording device 28 of the key control system 4. The price calculation program is recorded into the recording device 23f. The price calculation program is referred to based on the price setting rule recorded in the recording device 28.

The above price setting rules are examples, and another type of price setting rule may be applied.

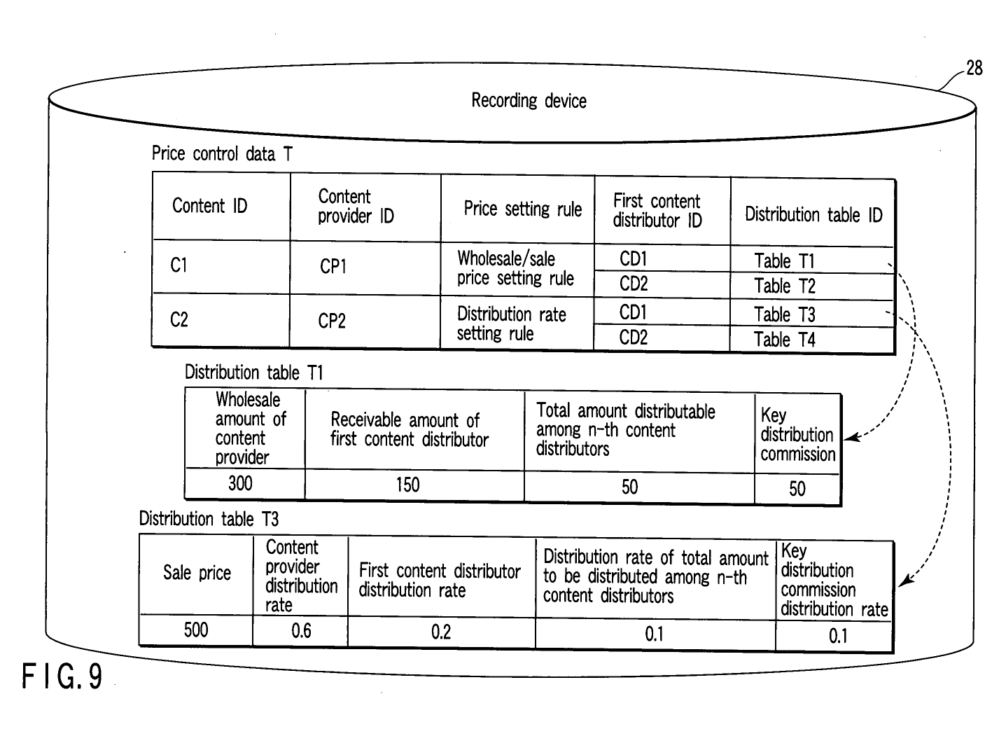

FIG. 9 is a figure showing an example of price control data recorded in the recording device 28.

Price control data T is set for respective content ID's “C1” and “C2”.

To the respective content ID's “C1” and “C2”, content provider ID's of respective contents “CP1” and “CP2” and price setting rules are corresponded.

To the respective content ID's “C1” and “C2”, reference data to the distribution tables set to the first content distributor are corresponded.

The distribution tables T1 to T4 are tables of formats according to the price setting rules, and include wholesale amounts and sale prices and the like.

For example, in the distribution table T1 to the wholesale/sale price setting rule, the wholesale amount of the content provider is set as 300, the receivable amount of the first content distributor as 150, the total amount distributable among the n-th content distributors as 50, and the key distribution commission is set as 50. By a calculation based on the price calculation program to the wholesale/sale price setting rule, the use right sale price to the user becomes 550 (=300+150+50+50). Note that the use right sale price charged to the user is typically collected from the user in form of a key sale charge.

When plural persons concerned with circulation are registered in the route data, distributable 50 is distributed among the first content distributor through the n-th content distributor.

For example, as shown in FIG. 4, when 2 ID's “CD1” and “CD2” are included in the route data, first, 150 is given to the first content distributor “CD1”, and the remaining 50 is distributed between the first content distributor “CD1” and the second content distributor “CD2”. As a result, the first content distributor “CD1” receives 175, and the second content distributor “CD2” receives 25.

In the distribution table T3 to the distribution rate setting rule, the content amount is 500. This 500 is distributed by the distribution rate set to the distribution table T3.

For example, as shown in FIG. 4, when 2 ID's “CD1” and “CD2” are included in the route data, as a result of calculation by the price calculation program of the distribution rate setting rule based on the distribution table T3, the dividends to respective persons concerned with circulation are as shown below.
The content provider “CP2”: 500×0.6=300.
The first content distributor “CD1”: 500×0.2+500×0.1/2=125.
The second content distributor “CD2”: 500×0.1/2=25.
The key control center: 500×0.1=50.

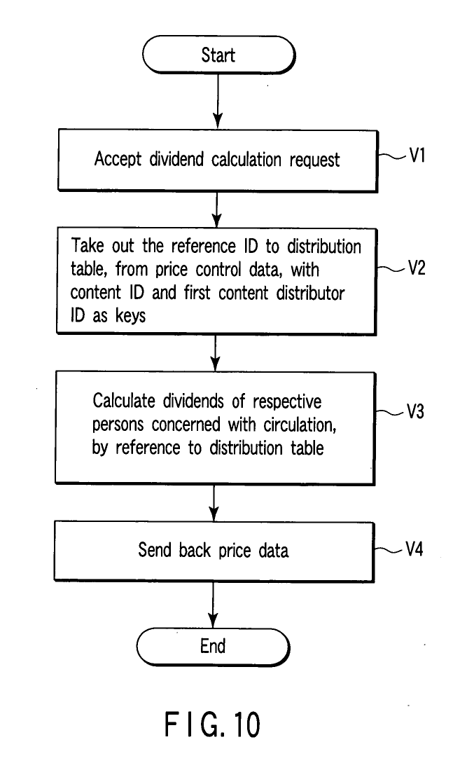

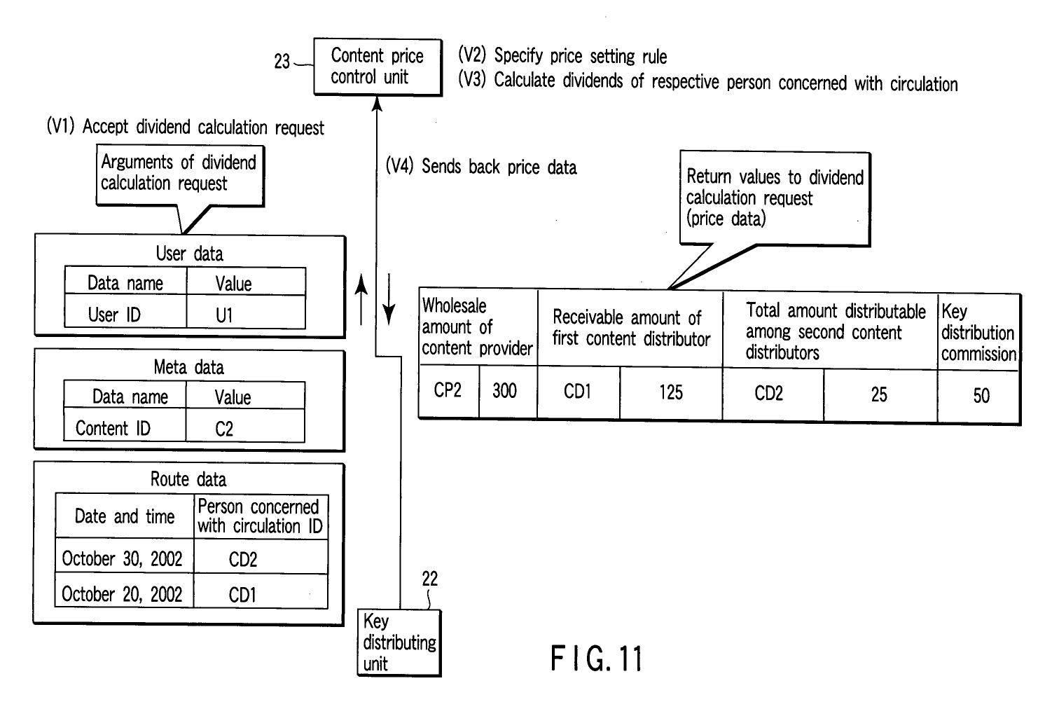

FIG. 10 is a flow chart showing an example of a sale price calculation process executed by the content price control unit 23 of the key control system 4.

FIG. 11 is a block diagram showing an example of data sent and received between the content price control unit 23 of the key control system 4 and the key distributing unit 22.

In step V1, the content price control unit 23 accepts a dividend calculation request from the key distributing unit 22.

The content price control unit 23 accepts user data including user ID, meta data including content ID, and route data as arguments from the key distributing unit 22. In the example in FIG. 11, user ID “U1”, content ID “C2”, and the route data showing first content distributor ID “CD1” and second content distributor ID “CD2” are supplied from the key distributing unit 22 to the content price control unit 23.

In step V2, the content price control unit 23 specifies the price setting rule “distribution rate setting rule”, based on the content ID “C2” and the first content distributor ID “CD1” and the price control data recorded in the recording device 28, and takes out the distribution table and the price calculation program.

Namely, the content price control unit 23 refers to the price control data, and specifies the price setting rule with the content ID and the first content distributor ID as keys, and specifies the distribution table and the price calculation program based on the specified price setting rule. In the example in FIG. 11, with the content ID “C2”, the first content distributor ID “CD1”, the distribution table “T3” is specified.

In step V3, the content price control unit 23 calculates dividends of the respective persons concerned with circulation. The content price control unit 23 refers to the specified distribution table, and calculates dividends of the respective persons concerned with circulation such as the content provider, the content distributor and the like. In the example in FIG. 11, based on the distribution table T3 and the price calculation program of the distribution rate setting rule, as described above, price data showing that 300 is distributed to the content provider “CP2”, 125 to the first content distributor “CD1”, 25 to the second content distributor, and 50 is distributed to the key control center, is obtained. The price data is a table showing, for example, dividends of the respective persons concerned with circulation.

In step V4, the content price control unit 23 sends the price data back to the key distributing unit 22.

Hereinafter, by reference to FIGS. 6 to 9, a price setting is explained.

The price control data shown in FIG. 9 is recorded in the recording device 28 of the key control system 4.

A content provider accesses via the sale price setting unit 8 of the content provision system 1 to the setting unit 23e of the content price control unit 23 of the key control system 4, and sets a content concerning itself in the distribution table.

In the same manner, a content distributor accesses via the sale price setting unit 15 of the content distribution system 2 to the setting unit 23e of the key control system 4, and sets a content concerning itself in the distribution table.

An authority to set the distribution table is determined according to role of a digital content on circulation.

Note that, as the role on the content circulation, there is a role as a content provider, a role as a content distributor, a role as a key control center and so forth.

The roles and authorities are changed according to the price setting rules. For example, in the example of the wholesale/sale price setting rule mentioned above, the content provider has authority to set “wholesale amount of the content provider”. The first content distributor has authority to set “receivable amount of the first content distributor”. Other n-th content distributors than the first content distributor has no authority. The key control center has authority to set “a key distribution commission”.

The roles and authorities explained herein are examples. Therefore, roles and authorities may be freely changed.

Further, persons concerned with circulation such as the content provider and content distributors may independently set local price control data, separately from the price control data of the key control system 4. The content price control unit 23 of the key control system 4, in calculating sale prices, sends the content ID and the user ID to the local content price control units 9 and 16 of the respective persons concerned with circulation, and receives data showing a sale price calculation result or data necessary for the sale price calculation.

For example, suppose that the content distributor is conducting a sale promotion campaign “to offer the 11th digital content 100 yen off, to a user who has purchased 10 digital contents”.

In such a case, the content distributor records its original local price control data for discounting the sale price for the 11th decoding key by 100 yen into its own system.

Then, suppose that a user who has already acquired 10 decoding keys for encrypted contents acquired from the content distributor request for the 11th decoding key to the key control center.

The content price control unit 23 determines the price for the content based on the local price control data recorded in the content distribution system 2.

In the embodiment, it is difficult to control individual information items concerning the content distributor and the user at the key control center, therefore, the local content price control units are arranged in the systems of the respective persons concerned with circulation.

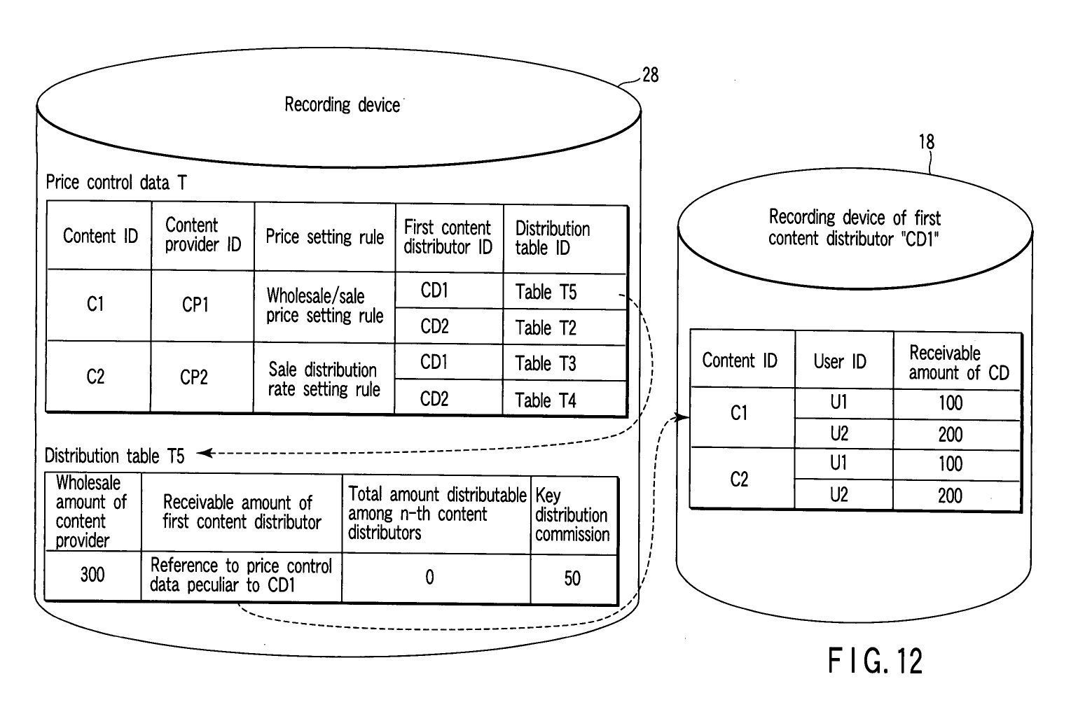

FIG. 12 is a figure showing an example of local price control data recorded out of the key control system 4.

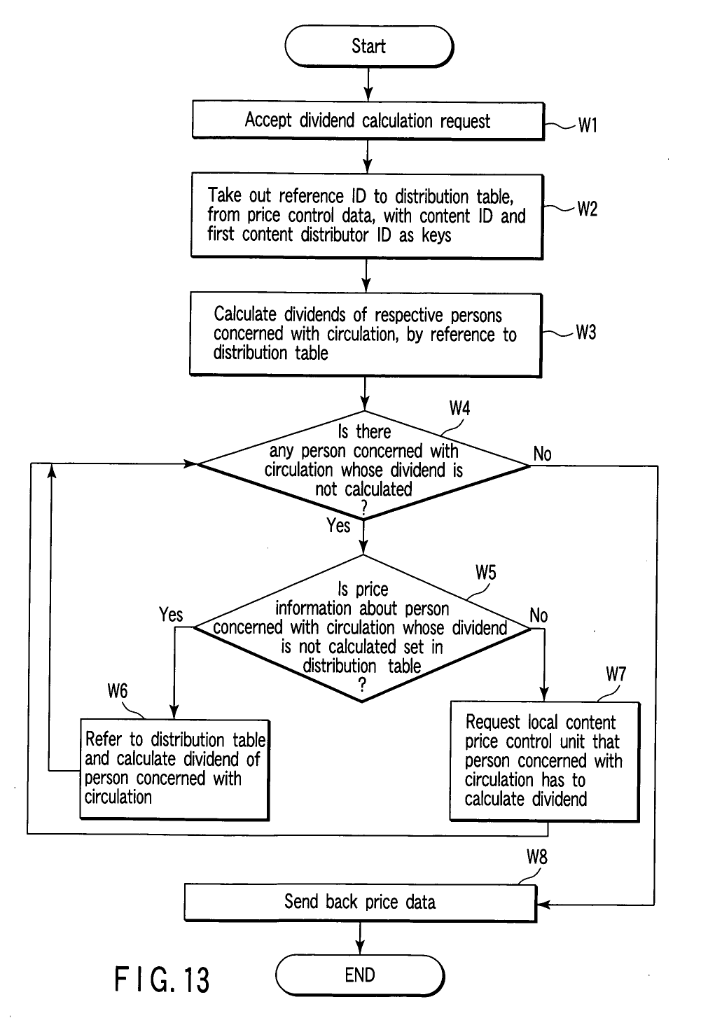

FIG. 13 is a flow chart showing an example of the process of the content circulation system 33 in the case where local price control data is recorded out of the key control system 4.

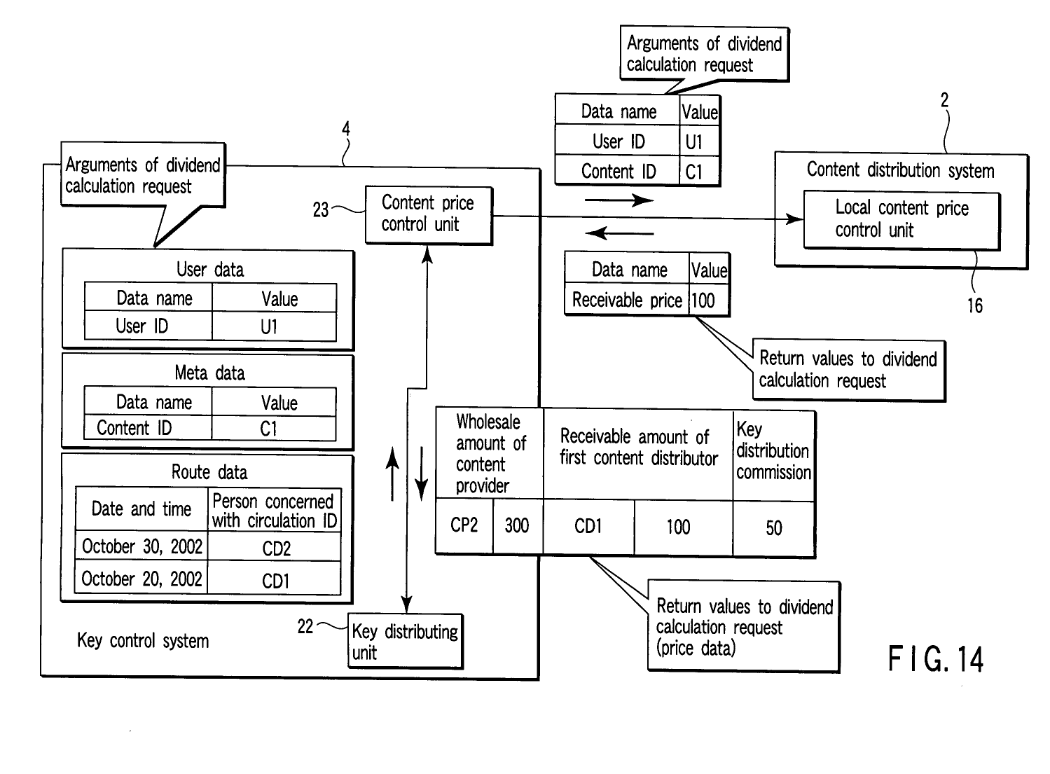

FIG. 14 is a block diagram showing data flow among the key distributing unit 22, the content price control unit 23, and the local content price control unit 16 in the case where local price control data is recorded out of the key control system 4.

In step W1, the content price control unit 23 accepts a dividend calculation request from the key distributing unit 22.

The content price control unit 23 accepts the user data, meta data, and route data as arguments from the key distributing unit 22. FIG. 14 shows examples of the user data, meta data, and route data.

In step W2, the content price control unit 23 specifies the price setting rule “wholesale/sale price setting rule”, based on the content ID “C1”, the first content distributor ID “CD1” and the price control data of the recording device 28, and takes out the distribution table and the price calculation program.

Namely, the content price control unit 23 refers to the price control data, and specifies the price setting rule with the content ID and the content distributor ID as keys, and specifies the distribution table and the price calculation program based on the specified price setting rule.

In the example in FIG. 14, with the content ID “C1”, the first content distributor ID “CD1”, the distribution table “T5” in FIG. 12 is specified.

In step W3, the content price control unit 23 calculates dividends of the respective persons concerned with circulation.

In step W4, the content price control unit 23 checks whether there is any person concerned with circulation whose dividend is not calculated or not.

If there is not any person concerned with circulation whose dividend is not calculated, step W8 is executed.

On the other hand, if there is any person concerned with circulation whose dividend is not calculated, in step W5, the content price control unit 23 checks whether the price information about the person concerned with circulation whose dividend is not calculated is set in the distribution table or not.

If the price information is set in the distribution table, in step W6, the content price control unit 23 refers to the distribution table and calculates the dividend of the person concerned with circulation. In the example in FIG. 12, in the distribution table T5, it is set that dividend of 300 is distributed to the content provider, dividend of 50 to the key control center, and dividend of 0 is to the n-th content distributor, accordingly, no dividend is distributed to the second content distributor “CD2”.

On the other hand, if the price information is not set in the distribution table, in step W7, the content price control unit 23, according to the reference data to the local content price control unit 16 of the person concerned with circulation, provides the user ID and the content ID to the local content price control unit 16, and requests it to calculate the dividend. In the example in FIG. 12, price information is not set in the price setting column of the first content distributor “CD1” in the table T5, instead, the reference data to the local content price control unit 16 peculiar to the first content distributor “CD1” is registered.

The local content price control unit 16 peculiar to the first content distributor ”CD1” independently calculates the dividend amount about the first content distributor “CD1”, based on the local price control data peculiar to it recorded in the recording device 18, user ID and content ID, and provides a result thereof to the content price control unit 23. In the example in FIG. 12, the amount in the case to sell the right to use of the content C1 to a user U1 is set as 100.

Note that, the local price setting table of the recording device 18 of the first content distributor “CD1” shown in FIG. 12 is an implementing example. There may be other implementing forms in the local content price control unit 16 or the recording device 18 of the first content distributor “CD1”.

Then, the content price control unit 23 accepts the dividend calculation result from the local content price control unit 16.

In step W8, the content price control unit 23 sends the price data showing the dividends to the respective persons concerned with circulation back to the key distributing unit 22.

Procedures in steps W3 to W7 depend on the price calculation program of the price setting rule, and may differ with the price setting rule.

The key distributing unit 22 of the key control system 4 provides the user ID in the user data, the content ID in the meta data, and the price data to the accounting unit 25.

The accounting unit 25 updates the key sale history data based on the user ID, content ID, and price data. The key sale history data is used for settlement.

When there is not settlement means between a person concerned with circulation to receive dividend and a key controller, for example, when a person concerned with circulation to receive dividend is an individual, to the person concerned with circulation to receive dividend, in the place of receiving payment of money, its own point data controlled by the key control system 4 is added. The point data may be used as the price to purchase content use right later.

Attribute data corresponding to person concerned with circulation ID included in route data is recorded in the recording device 29. The attribute control unit 24 of the key control system 4 controls the attribute data of this person concerned with circulation.

In the attribute control unit 24, respective this persons concerned with circulation are set into groups according to their attributes. Among users belonging to a same group, right to use of content is shared.

In the recording device 29, attribute data of the content provider, content distributor, and user are recorded respectively as a content provider table, content distributor table, and user table. A unique ID is allotted to each person concerned with circulation. To the person concerned with circulation ID, various attributes (name, address, and so forth) are corresponded.

Table 1 is the content provider table.

TABLE 1
Content provider table

| | Attributes (name, |
|---|---|
| ID | address, and so forth) |
| CP1 | Attributes of CP1 |
| CP2 | Attributes of CP2 |

Table 2 is the content distributor table.

TABLE 2
Content distributor table

| | Attributes (name, |
|---|---|
| ID | address, and so forth) |
| CD1 | Attributes of CD1 |
| CD2 | Attributes of CD2 |

Table 3 is the user table.

TABLE 3
User table

| User | Attributes (name, | Purchased content |
|---|---|---|
| ID | address, and so forth) | ID list |
| U1 | Attributes of U1 | Cont1 |
| U2 | Attributes of U2 | Cont2, Cont4 |

In Table 1 and Table 2, attribute data is corresponded per person concerned with circulation ID.

In Table 3, attribute data and purchased use right content ID list are corresponded per user ID.

Table 4 is a group table.

TABLE 4
Group table

| Group | Provider | Distributor | Content ID | User ID |
|---|---|---|---|---|
| ID | ID | ID | list | list |
| G1 | CP1 | CD1 | Cont1 | U1, U2 |
| G2 | CP2 | CD2 | Cont2, Cont3 | U2, U3, U4 |

In Table 4, per group ID, person concerned with circulation ID belonging to the group, and content ID list shared among plural persons concerned with circulation belonging to the group are corresponded.

Plural users belonging to a same group may share the right to use of content. For example, to the group “G1” in Table 4, users “U1” and “U2” belong.

In the same manner, to the group, the content provider, content distributor, and content are corresponded. In the example in Table 4, in the group “G1”, a content provider “CP1”, content distributor “CD1”, and content “Cont1” are set.

In the user table, the user “U1” has already purchased the use right of the content “Cont1”.

On the other hand, the users “U1” and “U2” belong to the group “G1” concerning the content “Cont1”. Therefore, the user “U2” has a right to use the content “Cont1”, even without purchasing the use right of the content “Cont1”.

Note that the table formats in the embodiment are examples. The attribute control unit 24 may control data and groups of persons concerned with circulation in other formats than those shown in Tables 1 to 4.

In the embodiment explained heretofore, it is possible to flexibly distribute the content sale money among plural persons concerned with circulation engaged in the circulation of the digital content. Further, it is possible to flexibly conduct accounting to the circulation of the digital content. In the embodiment, it is possible to provide various charging services to the circulation of the digital content, and conduct accounting according to charging services.

In the embodiment, it is possible for persons concerned with circulation to freely set price control data controlled in the key control system 4 from outside.

In the embodiment, it is possible to define various price setting rules according to various price distribution forms, and set the price setting rules per digital contents, and distribute prices.

In the embodiment, it is possible for persons concerned with circulation to set prices individually. Further, it is possible to make the sale price the total sum of amounts that persons concerned with circulation ask.

In the embodiment, it is possible to preset wholesale price of the content provider and sale price to the user, and distribute the different amounts between the sale prices and the wholesale prices among persons concerned with circulation.

In the embodiment, information concerning the persons concerned with circulation is recorded in route data of the digital content. When plural persons concerned with circulation are recorded in the route data, their distribution order is specified by date data. Therefore, it is possible to set a distribution rule according to the distribution order.

For example, it is possible to set such a distribution rule as one where most of sale money is acquired by the first content distributor, and the rest is distributed among other n-th content distributors than the first content distributor.

In the embodiment, it is possible to determine different authorities concerning price information according to roles of persons concerned with circulation. For example, it is possible for the content provider to determine a wholesale price, and for the first content distributor to determine a sale price and distribution proportion to other n-th content distributors, and for the key control center to determine a key distribution commission.

In the embodiment, it is possible for the person concerned with circulation to set the local price control data independently, separately from the price control data controlled in the key control center. Thereby, it is possible to distribute prices peculiar to respective persons concerned with circulation, without controlling individual price control data of content distributors and users all in the key control center.

In the embodiment, when sale money is distributed to persons concerned with circulation, prices are distributed according to a specified distribution method, and further point services are provided at necessity. For example, when part of prices is distributed to an individual, not cash but points are controlled by the point control unit. According to point values, purchase money is discounted when this individual purchases a decoding key.

In the embodiment, person concerned with circulation ID's are controlled by the attribute control unit 24 of the key control center. In the attribute control unit 24, groups of persons concerned with circulation may be controlled. Thereby, it is possible for users belonging to the same group to share the use right of a digital content, and various charging services may be provided. For example, such services as one where if a use right is purchased in unit of family, all the members of the family may use the digital content and so forth.

Note that the structural components equipped in the content distribution system 33 in the embodiment may be arranged differently so long as same actions may be realized, and the respective structural components may be freely combined, and further, the respective structural components may be freely separated.

Furthermore, various kinds of systems explained in the embodiment may be structured by plural computers, and the program may be distributed to plural computers and executed in mutual connections.

Moreover, to the various recording devices, for example, internal memories, hard disks, and the like are applied. The various recording devices may be controlled by a database control system.

The programs 5, 13, and 19 in the embodiment may be written into recording media 5a, 13a, and 19a such as, for example, a magnetic disk (flexible disk, hard disk, and the like), an optical disk (CD-ROM, DVD, and the like), a semiconductor memory and so forth, and applied to computers. Further, the programs 5, 13, and 19 may be transmitted via communication media and applied to computers. Computers read the programs 5., 13, and 19, and actions are controlled by the programs 5, 13, and 19, thereby the above functions are realized.

The present invention may be used in the distribution field of digital contents.

1. A content price control system comprising:
a unit which accepts content identification data to identify a digital content, and route data showing a circulation route of the digital content;
a unit which reads price control data in which the content identification data and distribution data showing a price distributing rule of the digital content are corresponded to each other, from a recording unit; and
an execution unit which executes a process of distributing prices of the digital content to persons concerned with circulation engaged in circulation of the digital content, based on the distribution data corresponding to the content identification data and the route data.

2. A content price control system according to claim 1, further comprising a unit which accepts a setting command of the price distributing rule about the persons concerned with circulation from the persons concerned with circulation, and sets the portion whose setting authority the persons concerned with circulation have of the distribution data based on the setting command.

3. A content price control system according to claim 1, wherein
the distribution data further comprises reference data showing a request destination to which dividend calculation is requested, and
the execution unit executes a process of providing a dividend calculation command to the request destination based on the reference data, and accepting a dividend calculation result from the request destination, and distributing prices of the digital content to the persons concerned with circulation based on the dividend calculation result.

4. A content price control system comprising:
a unit which accepts content identification data to identify an encrypted digital content, and route data showing a circulation route of the digital content;
a unit which reads price control data in which the content identification data and distribution data showing a price distributing rule of the digital content are corresponded to each other, from a recording unit; and
a unit which executes a process of distributing prices of the digital content to persons concerned with circulation engaged in circulation of the digital content, according to distribution of a decoding key for use in decoding the digital content, based on the distribution data corresponding to the content identification data and the route data.

5. A content price control system comprising:
a unit which accepts content identification data to identify a digital content, and route data showing a circulation route of the digital content;
a unit which reads price control data in which the content identification data, and distribution data showing a price setting rule set according to a accounting form of the digital content, and a price distributing rule of the digital content are corresponded to each other, from a recording unit;
a selecting unit which selects a program for executing a distribution process according to the accounting form by use of the distribution data and the route data as parameters, based on the price setting rule corresponding to the content identification data; and
a unit which executes a process of distributing prices of the digital content to persons concerned with circulation engaged in circulation of the digital content, based on the distribution data corresponding to the content identification data and the route data and the program selected by the selecting unit.

6. A local content price control system comprising:
a unit which accepts a dividend calculation command, from a content price control system which distributes prices of a digital content to persons concerned with circulation engaged in circulation of the digital content;
a unit which executes a dividend calculation, according to the calculation command, based on distribution data showing a price distributing rule of the digital content of local; and
a unit which provides a dividend calculation result to the content price control system.

7. A key control system comprising:
a key distributing unit which accepts content identification data to identify an encrypted digital content, and route data showing a circulation route of the digital content from a distribution destination of the digital content, and provides a decoding key corresponding,to the content identification data to the distribution destination;
a unit which reads price control data in which the content identification data and distribution data showing a price distributing rule of the digital content are corresponded to each other, from a recording unit;
an execution unit which executes a process of distributing prices of the digital content to persons concerned with circulation engaged in circulation of the digital content, based on the distribution data corresponding to the content identification data and the route data; and
an accounting unit which records price data obtained by the process by the execution unit.

8. A key control system according to claim 7, wherein
the key distributing unit accepts user ID showing the distribution destination from the distribution destination,
the key control system further comprises a unit which determines a group to which the distribution destination belongs based on the user ID, and changes the price data according to a specified discount rule according to the group to which the distribution destination belongs, and
the accounting unit records the price data which has been changed.

9. A key control system according to claim 7, further comprising a unit which accepts a setting command of a price distributing rule about the persons concerned with circulation from the persons concerned with circulation, and sets the portion whose setting authority the persons concerned with circulation have of the distribution data based on the setting command.

10. A key control system according to claim 7, wherein the distribution data further comprises
reference data showing a request destination to which a dividend calculation is requested, and
the execution unit executes a process of providing a dividend calculation command to the request destination based on the reference data, and accepting a dividend calculation result from the request destination, and distributing prices of the digital content to the persons concerned with circulation based on the dividend calculation result.

11. A content circulation system for distributing an encrypted digital content recorded in a content provision system to a distribution destination by a content distribution system, and distributing a decoding key for use in decoding the digital content to the distribution destination by a key control system,
the key control system comprising:
a unit which accepts content identification data to identify the digital content, and route data showing a circulation route of the digital content from the distribution destination, and provides the decoding key corresponding to the content identification data to the distribution destination;
a unit which reads price control data in which the content identification data and distribution data showing price distributing rule of the digital content are corresponded to each other, from a recording unit;
an execution unit which executes a process of distributing prices of the digital content to persons concerned with circulation engaged in circulation of the digital content, based on the distribution data corresponding to the content identification data and the route data; and
an accounting unit which records price data obtained by the process by the execution unit,
the content provision system executes a setting of the portion whose setting authority operator of the content provision system has of the distribution data, and
the content distribution system executes a setting of the portion whose setting authority operator of the content distribution system has of the distribution data.

12. A method of distributing prices of a digital content by a computer, comprising:
accepting content identification data to identify the digital content, and route data showing a circulation route of the digital content, and reading price control data in which the content identification data and distribution data showing a price distributing rule of the digital content are corresponded to each other, from a recording unit; and
executing a process of distributing prices of the digital content to persons concerned with circulation engaged in circulation of the digital content, based on the distribution data corresponding to the content identification data and the route data.

13. A recording medium for recording a program which causes a computer to function as:
a unit which accepts content identification data to identify a digital content, and route data showing a circulation route of the digital content;
a unit which reads price control data in which the content identification data and distribution data showing a price distributing rule of the digital content are corresponded to each other; and
an execution unit which executes a process of distributing prices of the digital content to persons concerned with circulation engaged in circulation of the digital content, based on the distribution data corresponding to the content identification data and the route data.

14. A recording medium according to claim 13, wherein the distribution data further comprises reference data showing a request destination to which dividend calculation is requested, and
the execution unit executes a process of providing a dividend calculation command to the request destination based on the reference data, and accepting a dividend calculation result from the request destination, and distributing prices of the digital content to the persons concerned with circulation based on the dividend calculation result.

15. A recording medium for recording a program which causes a computer to function as:
a unit which accepts a dividend calculation command, from a content price control system which distributes prices of a digital content to persons concerned with circulation engaged in circulation of the digital content;
a unit which executes a dividend calculation, according to the calculation command, based on distribution data showing a price distributing rule of the digital content of local; and
a unit which provides a dividend calculation result, to the content price control system.
